(19) United States
(12) Patent Application Publication
(10) Pub. No.: US 2026/0029426 A1
(43) Pub. Date: Jan. 29, 2026

(54) ULTRA-MICRO ELECTRODE USING LOW MELTING POINT METAL AND MANUFACTURING METHOD THEREOF

(71) Applicant: DONG-A UNIVERSITY RESEARCH FOUNDATION FOR INDUSTRY-ACADEMY COOPERATION, Busan (KR)

(72) Inventors: Hyo Jong LEE, Busan (KR); Jung Han KIM, Changwon-si (KR); Young Seo KIM, Suncheon-si (KR); Han Kyun SHIN, Changwon-si (KR); Young Jun CHO, Busan (KR)

(73) Assignee: DONG-A UNIVERSITY RESEARCH FOUNDATION FOR INDUSTRY-ACADEMY COOPERATION, Busan (KR)

(21) Appl. No.: 18/554,305

(22) PCT Filed: Jul. 3, 2023
(86) PCT No.: PCT/KR2023/009337

§ 371 Date: Oct. 3, 2025

(30) Foreign Application Priority Data
Jun. 8, 2023 (KR) 10-2023-0073371

(51) Int. Cl. G01Q 70/16; G01Q 60/60

(52) U.S. Cl. CPC G01Q 70/16; G01Q 60/60

(57) ABSTRACT

Poposed is an ultra-micro electrode using a low melting point metal and a method of manufacturing the same. The method includes preparing an insulating member having a hollow portion formed in a longitudinal direction, filling a metal in a liquid state having a melting point of 25 to 400° C. into the hollow portion of the insulating member, cooling to solidify the metal filled in the hollow portion of the insulating member, and manufacturing the ultra-micro electrode by forming a neck in the insulating member and the metal and breaking a portion in which the neck is formed.

### TECHNICAL FIELD

The present disclosure relates to an ultra-micro electrode using a low melting point metal and a method of manufacturing the same, which can be used as an electrode of a scanning electrochemical microscope, as well as a specimen for a micro-surface analysis using the scanning electrochemical microscope.

### BACKGROUND ART

Recently, in order to further improve the characteristics of a product of a corrosion or electrochemical sensor, including a secondary battery, based on the electrochemical reaction, measurement and analysis studies on the electrochemical reaction are actively conducted.

As one of the above-described measurement and analysis studies on the electrochemical reaction, research is being conducted on the development of an ultra-micro electrode for use in a scanning electrochemical microscope.

The scanning electrochemical microscope is advantageous in that it not only has very excellent spatial resolution by using the ultra-micro electrode, but also quantitatively measures local electrical activity through the shape of the ultra-micro electrode. In the scanning electrochemical microscope, the ultra-micro electrode is often used as a probe tip, but the shape of the ultra-micro electrode makes it easy to define a specific section of a material surface, so in some cases, the ultra-micro electrode is also used as a measurement substrate for the scanning electrochemical microscope.

As shown in FIG. 7, an ultra-micro electrode 20 is generally manufactured through the following method.

First, a tension force is applied to both ends of a tube 21 while applying heat to the central portion of the hollow tube 21, so the sectional area of the central portion of the tube 21 is reduced and a conductive wire 22 is inserted into the hollow portion of the tube 21. Next, after the inner surface of the tube 21 comes into close contact with the outer surface of the conductive wire 22 by applying heat to the central portion of the tube 21 into which the conductive wire 22 is inserted using a laser or the like and applying the tension force to both ends of the tube, the heat and the tension force are continuously applied to the tube 21 to cause the central portions of the tube 21 and the conductive wire 22 to be broken, thus manufacturing the ultra-micro electrode 20.

However, the conventional manufacturing method of the ultra-micro electrode 20 as described above is problematic in that it requires a process for causing the inner surface of the tube 21 and the outer surface of the conductive wire 22 to come into close contact with each other, so the manufacturing method is slightly complicated.

Further, as the temperature of the conductive wire 22 rises to about a melting point while the tube 21 comes into close contact with the conductive wire 22 and the central portions thereof are broken, an oxide film is formed on the conductive wire 22 due to air existing between the outer surface of the conductive wire 22 and the inner surface of the tube 21. This causes a problem in that contact between the inner surface of the tube 21 and the outer surface of the conductive wire 22 is not smoothly made.

### DISCLOSURE

### Technical Problem

The present disclosure has been made to solve the above-mentioned problems and difficulties, and an objective of the present disclosure provides an ultra-micro electrode using a low melting point metal and a method of manufacturing the same, intended to more smoothly provide the ultra-micro electrode which can be used as a probe of a scanning electrochemical microscope, as well as a specimen for analyzing a fine crystal grain.

The objectives of the present disclosure are not limited to the above-mentioned objective, and other objectives of the present disclosure that are not mentioned can be understood from the following description by those skilled in the art.

### Technical Solution

In order to accomplish the above objective, the present disclosure provides a method of manufacturing an ultra-micro electrode using a low melting point metal, the method including preparing an insulating member having a hollow portion formed in a longitudinal direction, filling a metal in a liquid state having a melting point of 25 to 400° C. into the hollow portion of the insulating member, cooling to solidify the metal filled in the hollow portion of the insulating member, and manufacturing the ultra-micro electrode by forming a neck in the insulating member and the metal and breaking a portion in which the neck is formed.

In order to accomplish the above objective, the present disclosure provides an ultra-micro electrode using a low melting point metal, the ultra-micro electrode including an insulating member having a hollow portion in a longitudinal direction, and having a diameter that gradually increases from one end to a predetermined point on the other side, and a metal provided in the insulating member, and having a melting point of 25 to 400° C., one side of the metal being exposed to an outside of one side of the insulating member.

### Advantageous Effects

According to embodiment of the present disclosure, an ultra-micro electrode using a low melting point metal and a method of manufacturing the same can be used as a probe tip of a scanning electrochemical microscope and as a specimen of the scanning electrochemical microscope.

Further, as an ultra-micro electrode is manufactured by filling liquid metal into a hollow portion formed in an insulating member, the metal is conveniently and effectively adhered to an inner surface of the insulating member when manufacturing the ultra-micro electrode.

### DESCRIPTION OF DRAWINGS

FIG. 1 is a flowchart showing the sequence of a method of manufacturing an ultra-micro electrode using a low melting point metal according to an embodiment of the present disclosure.

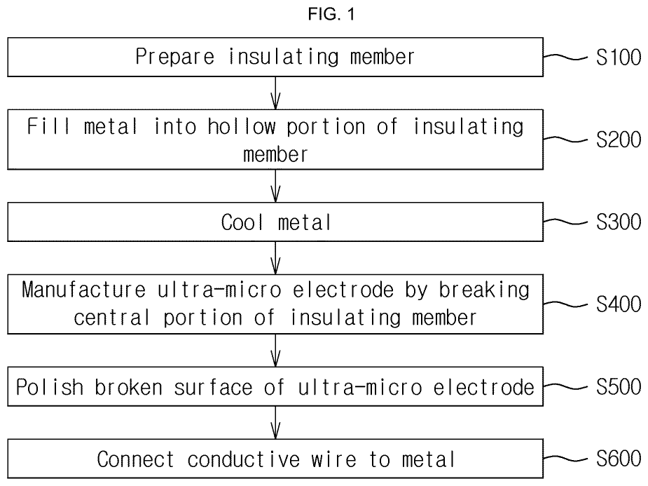

FIG. 2 is a conceptual view illustrating an ultra-micro electrode using a low melting point metal and a method of manufacturing the same according to embodiments of the present disclosure.

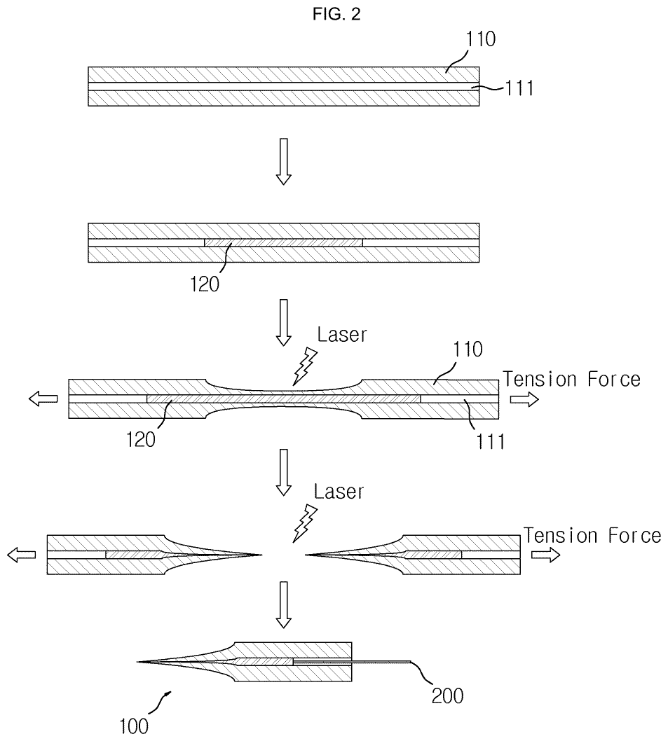

FIG. 3 is a photograph showing the result of analyzing an ultra-micro electrode manufactured according to Example 1 using a USB microscope according to Test Example 1.

FIGS. 4 to 6 are photographs showing the result of analyzing the ultra-micro electrode manufactured according to Example 1 using a scanning electron microscope.

FIG. 7 is a conceptual view illustrating a conventional method of manufacturing an ultra-micro electrode.

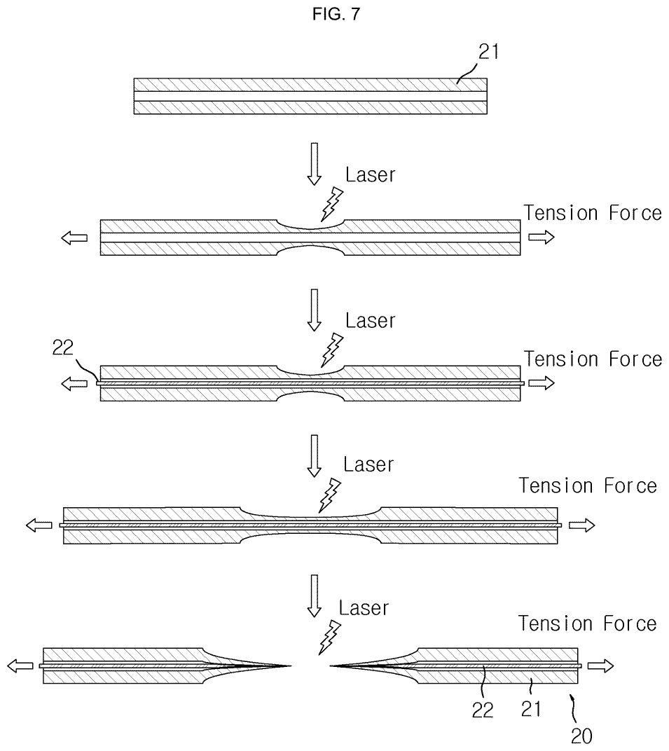

### BEST MODE

In order to accomplish the above objective, the present disclosure provides a method of manufacturing an ultra-micro electrode using a low melting point metal, the method including preparing an insulating member having a hollow portion formed in a longitudinal direction, filling a metal in a liquid state having a melting point of 25 to 400° C. into the hollow portion of the insulating member, cooling to solidify the metal filled in the hollow portion of the insulating member, and manufacturing the ultra-micro electrode by forming a neck in the insulating member and the metal and breaking a portion in which the neck is formed.

The filling the metal may heat the insulating member above the melting point of the metal, and may fill the metal in the liquid state into the heated insulating member.

The filling the metal may fill metal containing at least one gallium, indium, tin, antimony, cadmium, thallium, lead, bismuth, Wood's Metal, and alloys thereof.

In the manufacturing the ultra-micro electrode, a constant tension force may be applied to first and second ends of the insulating member in first and second directions, respectively, while heating a central portion of the insulating member having the metal obtained in the solidifying, thus forming the neck in the central portion, and the central portion having the neck may be broken, thus manufacturing the ultra-micro electrode.

In the preparing the insulating member, the insulating member containing at least one of borosilicate glass, silicon oxide and aluminum silicon oxide may be prepared.

In order to accomplish the above objective, the present disclosure provides an ultra-micro electrode using a low melting point metal, the ultra-micro electrode including an insulating member having a hollow portion in a longitudinal direction, and having a diameter that gradually increases from one end to a predetermined point on the other side, and a metal provided in the insulating member, and having a melting point of 25 to 400° C., one side of the metal being exposed to an outside of one side of the insulating member.

### Mode for Invention

The above and other objectives, features, and other advantages of the present disclosure will be more clearly understood from the following detailed description when taken conjointly with the accompanying drawings. The present disclosure may be embodied in many different forms and should not be construed as being limited to only the embodiments set forth herein. These embodiments are provided to make those skilled in the art more thoroughly and completely understand the present disclosure. Meanwhile, terms used in this specification are for describing embodiments and are not intended to limit the present disclosure. As used herein, the singular forms are intended to include the plural forms as well, unless the context clearly indicates otherwise.

Hereinafter, an ultra-micro electrode using a low melting point metal and a method of manufacturing the same according to embodiments of the present disclosure will be described with reference to the accompanying drawings.

When describing the ultra-micro electrode using the low melting point metal and the method of manufacturing the same according to embodiments of the present disclosure, the same reference numerals are used throughout the drawings to designate the same or similar components.

The method of manufacturing the ultra-micro electrode using the low melting point metal according to an embodiment of the present disclosure is a method for manufacturing an ultra-micro electrode 100 using a low melting point metal according to another embodiment of the present disclosure, and includes an insulating member preparation step S100, a filling step S200, a cooling step S300, and an ultra-micro electrode manufacturing step S400.

The ultra-micro electrode 100 using the low melting point metal according to another embodiment of the present disclosure includes an insulating member 110 and a metal 120.

The insulating member 110 having a capillary shape with a hollow portion 111 formed in a longitudinal direction is prepared (S100).

The insulating member 110 prepared in the insulating member preparation step S100 may be made of any material as long as it is made of the material with insulating properties, and may be made of a glass material, for example, at least one of borosilicate glass, silicon oxide, and aluminum silicon oxide.

The inner diameter of the insulating member 110 prepared in the insulating member preparation step S100 may range from several to hundreds micrometers, but may range from 100 to 1000 mm for convenience to be smoothly broken in the ultra-micro electrode manufacturing step S400.

A liquid metal 120 is filled into the hollow portion 111 formed in the longitudinal direction of the insulating member 110 prepared in the insulating member preparation step S100 (S200).

The filling step S200 may be a step in which the metal 120 is heated above a melting point to be melted and the molten metal 120 in a liquid state is filled in the hollow portion 111 of the insulating member 110.

When the metal 120 is filled into the hollow portion 111 of the insulating member 110 in the filling step S200, the metal 120 as well as the insulating member 110 may be heated above the melting point of the filled metal 120 to smoothly fill the metal without solidification.

The filling step S200 may be a step in which the metal 120 in the liquid state is filled into the hollow portion 111 of the insulating member 110 to fill the liquid metal 120 into a portion or an entire portion including a central portion of an internal space of the insulating member 110.

The metal 120 filled into the insulating member 110 in the filling step S200 may have the melting point of 25 to 400° C. to be smoothly filled.

If the melting point of the metal 120 filled into the insulating member 110 in the filling step S200 is less than 25° C., the melting point is so low that the metal 120 is melted when the ultra-micro electrode 100 is actually used, and it may be difficult to use the ultra-micro electrode 100.

If the melting point of the metal 120 filled into the insulating member 110 in the filling step S200 is more than 400° C., the melting point of the metal 120 is too high, so that it is difficult to melt the metal 120 and thereby the metal 120 may not be smoothly filled.

The metal 120 filled into the insulating member 110 in the filling step S200 may have the melting point of 25 to 400° C., and may include at least one of gallium (Ga), indium (In), tin (Sn), antimony (Sb), cadmium (Cd), thallium (Tl), lead (Pb), bismuth (Bi), Wood's Metal, and alloys thereof, for example.

Preferably, the metal 120 filled into the insulating member 110 in the filling step S200 may have the melting point of 25 to 200° C., more preferably 50 to 100° C.

More preferably, the metal 120 filled into the insulating member 110 in the filling step S200 may be Wood's Metal.

Meanwhile, Wood's Metal is composed of 50 wt % bismuth, 26.7 wt % lead, 13.3 wt % tin, and 10 wt % cadmium, and is known to have the melting point of about 70° C.

A method of filling the metal 120 in the filling step S200 is not limited to a specific method as long as it is possible to fill the metal 120 without forming bubbles in the insulating member 110. Examples of the method may include a suction method of filling the liquid metal 120 by creating a negative pressure in the interior of the insulating member 110 having the hollow portion 111, and a method of directly injecting the liquid metal 120 into the hollow portion 111 of the insulating member 110.

The filling step S200 may be a step of filling the metal 120 into the hollow portion 111 of the insulating member 110 without forming bubbles in the filled metal 120.

The filling speed of the metal 120 in the filling step S200 is not limited as long as no bubbles are formed in the metal 120 filled into the hollow portion 111 of the insulating member 110, and may range from 40 to 60 mm/s, for example. In this case, the unit may mean the length of the metal 120 filled in the insulating member 110 with respect to time.

If the filling speed of the metal 120 is less than 40 mm/s in the filling step S200, the filling speed of the metal 120 is too slow, so the productivity of the ultra-micro electrode 100 may be decreased. If the filling speed exceeds 60 mm/s, the filling speed of the metal 120 is too fast, so bubbles may be formed in the metal 120 filled in the insulating member 110 or the metal 120 may not be in close contact with the inner surface of the insulating member 110.

In the filling step S200, the metal 120 filled in the insulating member 110 is cooled and solidified (S300).

The cooling step S300 may be a step of cooling the metal 120 so that the metal 120 filled in the insulating member 110 is not removed from the insulating member 110.

As the metal filled in the insulating member 110 in the filling step S200 is cooled in the cooling step S300, the insulating member 110 including the metal 120 along the longitudinal direction in the inner central portion may be prepared, and the outer surface of the metal 120 may be in close contact with the inner surface of the insulating member 110.

In the cooling step S300, the metal 120 may be cooled below the melting point of the metal 120, for example, at room temperature, but is not limited thereto. The cooling temperature may be changed depending on a user's needs.

A neck is formed in the insulating member 110 and the metal 120 obtained in the cooling step S300, and a portion where the neck is formed is broken, thus manufacturing the ultra-micro electrode 100 (S400).

The ultra-micro electrode manufacturing step S400 may be a step in which a tension force is applied to the insulating member 110 while heating the central portion of the insulating member 110 having the metal 120 along the longitudinal direction in the inner central portion obtained in the cooling step S300, thus forming the neck in the central portion, and the central portion having the neck is broken, thus manufacturing the ultra-micro electrode 100.

Thus, a surface of the metal 120 may be exposed on a broken surface of the ultra-micro electrode 100 manufactured in the ultra-micro electrode manufacturing step S400.

In the ultra-micro electrode manufacturing step S400, a constant tension force is applied to one end and the other end of the insulating member 110 in the other direction and one direction, respectively, while heating the central portion of the insulating member 110 having the metal 120 therein, thus stretching the insulating member 110 and thereby forming the neck in the central portions of the metal 120 and the insulating member 110, and the central portion having the neck is broken, thus manufacturing the ultra-micro electrode 100.

In the ultra-micro electrode manufacturing step S400, when the tension force is applied to one end and the other end of the insulating member 110 in the other direction and one direction, respectively, it is preferable that the tension force applied to one end of the insulating member 110 be the same as the tension force applied to the other end.

In the ultra-micro electrode manufacturing step S400, if the same and constant tension force is applied to one end and the other end of the insulating member 110 in the other direction and one direction, respectively, the neck may also be formed in the metal 120 provided in the central portion of the insulating member 110 as the neck is formed in the central portion of the insulating member 110.

The metal 120 and the insulating member 110 having the neck formed in the central portions thereof in the ultra-micro electrode manufacturing step S400 may be broken by applying the tension force to one end and the other end of the insulating member 110 in the other direction and one direction, respectively, or by heating the central portions having the neck using a laser or the like. However, the present disclosure is not limited thereto.

As a portion having the neciking is broken by applying the tension force to one end and the other end of the insulating member 110 in the other direction and one direction, respectively, to manufacture the ultra-micro electrode 100 in the ultra-micro electrode manufacturing step S400, the manufactured ultra-micro electrode 100 may have the shape of a micro needle with a diameter that gradually increases from one end to a predetermined point on the other side.

The ultra-micro electrode 100 manufactured in the ultra-micro electrode manufacturing step S400 may include the hollow portion 111 formed in the longitudinal direction, the insulating member 110 having the diameter that gradually increases from one end to a predetermined point on the other side, and the metal 120 that is provided in the insulating member 110 and has the melting point of 25 to 200° C.

The metal 120 may be filled through the hollow portion 111 of the insulating member 110 to be provided inside the insulating member 110, and may be provided from one end of the insulating member 110 to a predetermined point on the other side.

One side of the metal 120 may be exposed to the outside of the broken surface that is one side of the insulating member 110 to use the ultra-micro electrode 100 as a probe or specimen of the scanning electrochemical microscope.

The method of manufacturing the ultra-micro electrode using the low melting point metal according to an embodiment of the present disclosure may further include a polishing step S500 and a conductive wire connecting step S600.

The polishing step S500 and the connecting step S600 may be performed after the ultra-micro electrode manufacturing step S400.

The polishing step S500 may be a step of polishing the broken surface of the ultra-micro electrode 100 manufactured in the ultra-micro electrode manufacturing step S400.

As the central portions of the insulating member 110 and the metal 120 are broken to manufacture the ultra-micro electrode 100 in the ultra-micro electrode manufacturing step S400, unnecessary uneven portions may be formed on the broken surface of the manufactured ultra-micro electrode 100. For this reason, when the ultra-micro electrode 100 is used as the probe tip or specimen of the scanning electrochemical microscope, one side of the metal 120 is not exposed, so an electrochemical analysis may not be performed somewhat smoothly.

In the polishing step S500, the broken surface where one side of the metal 120 of the ultra-micro electrode 100 manaufactured in the ultra-micro electrode manufacturing step S400 is exposed may be polished using a mechanical polishing method and an electrochemical polishing method. For example, the polishing step may polish the broken surface of the ultra-micro electrode 100 manaufactured in the ultra-micro electrode manufacturing step S400 by ion beam milling using a focused ion beam (FIB) equipment.

In the connecting step S600, the conductive wire 200 may be connected to the metal 120 that is povided in the insulating member 110 of the ultra-micro electrode 100.

In the connecting step S600, the conductive wire 200 may be introduced through the hollow portion 111 formed on the other side facing the broken surface that is one side of the insulating member 110, thus connecting the conductive wire 200 to the other side of the metal 120.

The conductive wire 200 used in the connecting step S600 is connected to the metal 120 to connect the ultra-micro electrode 100 to the scanning electrochemical microscope, and may be formed of a conductive material, for example, a conductive material containing at least one of copper (Cu), carbon nanotubes, gold (Au), silver (Ag), and platinum (Pt).

Preferably, the conductive wire 200 used in the connecting step S600 may be relatively smaller in diameter than the hollow portion 111 formed in the insulating member 110 so that the conductive wire is introduced through the hollow portion 111 of the insulating member 110 to be connected to the metal 120.

### Example 1

The insulating member 110 that is formed of borosilicate glass, has the outer diameter of 1 mm, and has a capillary shape with the hollow portion 111 having the diameter of 300 mm in the central portion was prepared.

The metal 120 formed of Wood's Metal with the melting point of about 70° C. was prepared, and the prepared metal 120 was melted to become the liquid state.

One end of the insulating member 110 was immersed in the liquid metal 120, and air was sucked into the hollow portion 111 formed in the other end of the insulating member 110 using a syringe, thus creating the negative pressure in the hollow portion 111 of the insulating member 110. By sucking the liquid metal 120 into the interior of the insulating member 110 having the hollow portion 111 in this way, the metal 120 was filled into a portion including the central portion of the internal space of the insulating member 110. Here, when filling the metal 120, the insulating member 100 was heated to 70° C., and no bubbles were formed in the metal 120 filled in the hollow portion 111 of the insulating member 110.

The metal 120 filled in the insulating member 110 was cooled at room temperature to be solidified.

The neck was formed in the central portion by applying a constant tension force to one end and the other end of the insulating member 110 in the other direction and one direction, respectively, while heating the central portion of the insulating member 110 having the metal 120 in the central portion using a laser puller (model name: P-2000, manufacturer: Sutter), and the central portion having the neck was heated using the laser, thus breaking the insulating member 110 and the metal 120 and thereby manufacturing the ultra-micro electrode 100. At this time, the tension force applied to one end and the other end of the insulating member 110 was made to be the same.

The broken surface of the manufactured ultra-micro electrode 100 was polished using the forced ion beam (FIB) device.

### Test Example

In Test Example, the surface of the ultra-micro electrode 100 was analyzed using a USB microscope and a scanning electron microscope to check whether the electrode was smoothly manufactured using the manufacturing method according to Example 1.

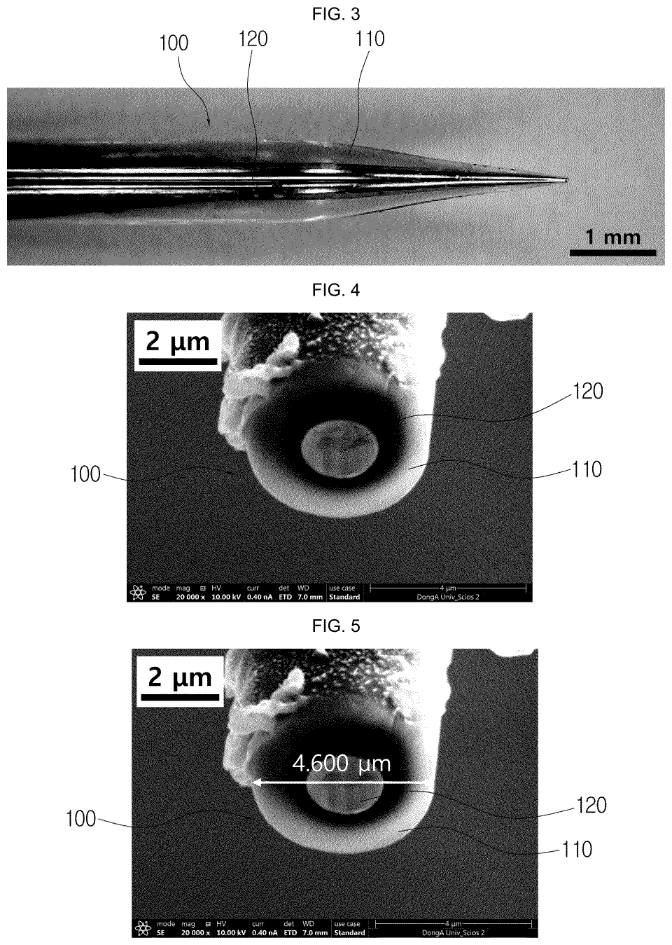

USB microscope images and scanning electron microscope images obtained according to the analysis result are shown in FIGS. 3 to 6.

FIG. 3 is an image obtained by analyzing the ultra-micro electrode 100 manufactured through the manufacturing method according to Example 1 using the USB microscope.

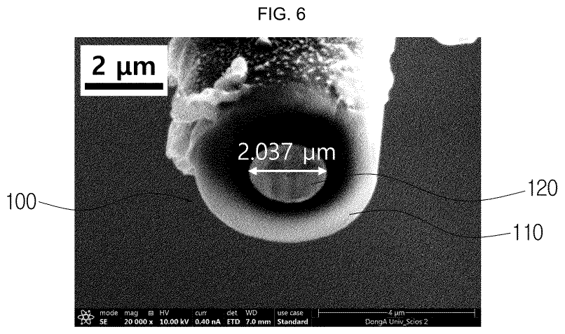

FIGS. 4 to 6 are images obtained by analyzing the ultra-micro electrode 100 manufactured according to Example 1 using the scanning electron microscope.

Referring to FIG. 3, it can be seen that the outer surface of the metal 120 and the inner surface of the insulating member 110 of the ultra-micro electrode 100 manufactured through the manufacturing method according to Example 1 are in close contact with each other. Thus, when manufacturing the ultra-micro electrode 100 through the manufacturing method according to an embodiment of the present disclosure, it is possible to conveniently manufacture the ultra-micro electrode 100 in which the outer surface of the metal 120 and the inner surface of the insulating member 110 are in close contact with each other without going through a separate process for causing the inner surface of the insulating member 110 to come into close contact with the outer surface of the metal 120.

In addition, referring to FIGS. 4 to 6, when manufacturing the ultra-micro electrode 100, it can be seen that one side of the metal 120 is effectively exposed to the outside of one side of the insulating member 110 upon polishing the broken surface of the ultra-micro electrode 100.

Further, as the neck is formed in the central portion by applying the constant tension force to one end and the other end of the insulating member 110 in the other direction and one direction, respectively, while heating the central portion of the insulating member 110 having the metal 120 in the central portion using the laser puller when manufacturing the ultra-micro electrode 100, it can be seen that the outer and inner diameters of the ultra-micro electrode 100, which are formed by reducing the outer and inner diameters of the insulating member 110, are 4.600 μm and 2.037 μm, respectively.

Those skilled in the art to which the present invention pertains will understand that the present invention can be implemented in other specific forms without changing its technical idea or essential features. Therefore, the above-described embodiments should be understood in all respects as illustrative and not restrictive. The scope of the present invention is indicated by the scope of the claims described below rather than a detailed description, and all changes or modifications derived from claims and equivalences thereof should be construed as being included in the scope of the present invention.

### Industrial Applicability

According to the present disclosure, an ultra-micro electrode using a low melting point metal and a method of manufacturing the same can be used in the field of scanning electrochemical microscope technology, which can analyze local electrochemical behavior at liquid/solid, liquid/gas, and liquid/liquid interfaces.

1. A method of manufacturing an ultra-micro electrode using a low melting point metal, the method comprising:
preparing an insulating member having a hollow portion formed in a longitudinal direction;
filling a metal in a liquid state having a melting point of 25 to 400° C. into the hollow portion of the insulating member;
cooling to solidify the metal filled in the hollow portion of the insulating member; and
manufacturing the ultra-micro electrode by forming a neck in the insulating member and the metal and breaking a portion in which the neck is formed.

2. The method of claim 1, wherein the filling the metal heats the insulating member above the melting point of the metal, and fills the metal in the liquid state into the heated insulating member.

3. The method of claim 1, wherein the filling the metal fills metal containing at least one of gallium, indium, tin, antimony, cadmium, thallium, lead, bismuth, Wood's Metal, and alloys thereof.

4. The method of claim 1, wherein, in the manufacturing the ultra-micro electrode, a constant tension force is applied to first and second ends of the insulating member in first and second directions, respectively, while heating a central portion of the insulating member having the metal obtained in the solidifying, thus forming the neck in the central portion, and the central portion having the neck is broken, thus manufacturing the ultra-micro electrode.

5. The method of claim 1, wherein, in the preparing the insulating member, the insulating member containing at least one of borosilicate glass, silicon oxide and aluminum silicon oxide is prepared.

6. An ultra-micro electrode using a low melting point metal, the ultra-micro electrode comprising:
an insulating member having a hollow portion in a longitudinal direction, and having a diameter that gradually increases from one end to a predetermined point on the other side; and
a metal provided in the insulating member, and having a melting point of 25 to 400° C., one side of the metal being exposed to an outside of one side of the insulating member.
